(19) United States
(12) Patent Application Publication
(10) Pub. No.: US 2004/0074269 A1
(43) Pub. Date: Apr. 22, 2004

(54) Anti-break cylindrical lever lock

(76) Inventor: Han Young Lee, Deagu (KR)

Correspondence Address: PARK & SUTTON LLP, 3255 WILSHIRE BLVD, SUITE 1110, LOS ANGELES, CA, 90010, US

(21) Appl. No.: 10/277,242

(22) Filed: Oct. 21, 2002

(51) Int. Cl. E05B 13/10

(52) U.S. Cl. 70/224; 70/472

(57) ABSTRACT

An anti-break cylindrical lever lock is provided. The lock comprises an outside lever having a key cylinder, a locking bar, an outer spindle, an inner spindle, a first protection part provided between the outside lever and the outer spindle, and a second protection part provided between the key cylinder and the inner spindle. When the lock is locked, the outer spindle and the inner spindle cannot be rotated and thus cannot make the locking bar retract. When the lock is locked and external force is exerted on the outside lever, the first protection part make the outside lever rotate idle separately from the outer spindle, and the second protection part make the key cylinder rotate idle separately from the inner spindle, thereby prevent the parts of the lock from being deformed or broken.

### BACKGROUND OF THE INVENTION

The present invention relates to a cylindrical lever lock. More particularly, the invention relates to a cylindrical lever lock that is not broken even though a strong force is exerted on the outside lever of the lever lock.

A cylindrical lever lock has a cylindrical body, and an outside lever connected to the cylindrical body. The outside lever has a key cylinder. The cylindrical body has an inner spindle that is engaged with the key cylinder, and an outer spindle that is engaged with the outside lever. When the lever lock is locked by pushing a locking button inside of a room, the outer spindle is prevented from rotating and thus the outside lever is prevented from rotating. A locking bar, which protrudes out of cylindrical body of the lever lock and is inserted into a recess in a doorframe, cannot be moved when the outer spindle is prevented from rotating. In this way, a door with the lever lock is kept locked. When A key is inserted into the key cylinder and rotated, a key cylinder rod rotates the inner spindle, which in turn makes the locking bar retract into the cylindrical lever lock, allowing the door to be opened.

FIG. 2 shows how the outside lever is rotationally engaged with the outer spindle. A rotating tube 8″ is engaged with two inward protrusion 162″ of a spring bracket 16″. The protrusions 162″ also engage with two side recesses of the outer spindle. When the outer spindle is prevented from rotating, the rotating tube 8″ is prevented from rotating, and thus the outside lever, which is integral with the rotating tube, is prevented from rotating.

Since the end of the outside lever is a few inches distant from the center of the cylindrical lever lock, when an external force is exerted on the end of the outside lever, the force is magnified by the lever effect of the outside lever and becomes a strong torque that tries to rotate the inside rotating elements of the lever lock. Therefore, not like a plain cylindrical lock that has a circular knob, inside elements of a cylindrical lever lock are often easily deformed or broken causing the lock to malfunction.

### SUMMARY OF THE INVENTION

The present invention contrives to solve the disadvantages of prior art.

Therefore, an object of the invention is to provide an anti-break cylindrical lever lock that is not easily deformed or broken by external force.

Another object of the invention is to provide an anti-break cylindrical lever lock that has a simple and reliable anti-break mechanism.

Still another object of the invention is to provide an anti-break cylindrical lever lock that has separately rotatable parts when an excessive force is exerted.

To achieve the above-described objects, the invention provides a cylindrical lever lock that comprises an outside lever having a key cylinder, a locking bar, an outer spindle, an inner spindle, a first protection part provided between the outside lever and the outer spindle and a second protection part provided between the key cylinder and the inner spindle. The outer spindle and the inner spindle are connected to the locking bar in a manner that rotation of the outer spindle or the inner spindle makes the locking bar protrude or retract. The outer spindle and the inner spindle cannot be rotated when the cylindrical lever lock is locked, and the outer spindle and the inner spindle can be rotated when the cylindrical lever lock is unlocked. When the cylindrical lever lock is locked and external force is exerted on the outside lever, the first protection part makes the outside lever rotate idle separately from the outer spindle, and the second protection part makes the key cylinder rotate idle separately from the inner spindle.

The first protection part has a rotating tube that rotates integrally with the outside lever, a coupling cylinder assembly that is rotationally engaged with the rotating tube. The coupling cylinder assembly is also rotationally engaged with the outer spindle. The rotating tube rotates separately from the coupling cylinder assembly when the cylindrical lever lock is locked and external force is exerted on the outside lever.

The second protection part has a unlocking bracket and a connection bracket assembly. The connection bracket assembly is rotationally engaged with the key cylinder and the unlocking bracket is rotationally engaged with the inner spindle. The connection bracket assembly rotates separately from the unlocking bracket when the cylindrical lever lock is locked and external force is exerted on the outside lever.

The coupling cylinder assembly has a coupling cylinder, a coupling rod and an elastic spring. The rotating tube has a longitudinal inclined groove and the coupling cylinder has a guide channel. The longitudinal inclined groove and the guide channel are aligned and the coupling rod is received in the longitudinal inclined groove and the guide channel. The elastic spring presses the coupling rod radially inward. When the cylindrical lever lock is locked and external force is exerted on the outside lever, the coupling rod moves out of the longitudinal inclined groove and slides on the rotating tube until the longitudinal inclined groove and the guide channel are aligned again. In this way, the rotating tube rotates separate from the coupling cylinder assembly.

Preferably, the rotating tube further has a ring and the longitudinal inclined groove is provided on the ring. Also, preferably the ring is made of hardened steel.

The cylindrical lever lock further has a spring bracket, and the spring bracket has a coupling protrusion that is received in a coupling recess provided in the coupling cylinder and in a side recess provided in the outer spindle. In this way, the coupling cylinder is rotationally engaged with the outer spindle.

The connection bracket assembly has a connection bracket, a connection bracket cylinder and a connection bracket spring. The connection bracket cylinder is rotationally engaged with the key cylinder. The connection bracket cylinder has a transverse cut portion, a circular step and an annular groove. The unlocking bracket can rotate on the circular step. The connection bracket rests on the transverse cut portion, and the connection bracket spring is received in the annular groove. The connection bracket has a rounded surface portion and a protruding stop adjacent the rounded surface portion. The unlocking bracket has a transverse cut groove and the rotating tube further has an inclined groove. The connection bracket can move transversely in the transverse cut groove. The rounded surface portion is received in the inclined groove and the protruding stop is positioned outside the transverse cut groove so that the connection bracket cylinder can rotate separately from the unlocking bracket when the cylindrical lever lock is locked. When the cylindrical lever lock is unlocked by a key, the rotation of the key cylinder rotates the connection bracket cylinder relative to the rotating tube making the rounded surface portion slide on the inclined groove against the force of the connection bracket spring and the protruding stop be inserted into the transverse cut groove. In this way, the rotation of the connection bracket cylinder rotates the unlocking bracket.

The connection bracket further has a spring recess in which the connection bracket spring is received. The key cylinder has a key cylinder rod, and the connection bracket cylinder has a rectangular hole, and the key cylinder rod is inserted into the rectangular hole. The unlocking bracket further has a column that is inserted into a slot provided in the inner spindle.

The second protection part further has a cover that covers the unlocking bracket between the unlocking bracket and the inner spindle.

The advantages of the present invention are numerous in that: (1) excessive external force is not transferred to the internal elements; (2) thus the locking parts and other elements are prevented from being deformed or broken; (3) a safer and more durable cylindrical lever lock is provided; and (4) anti-break feature is obtained with low additional cost.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a cross-sectional drawing of an anti-break cylindrical lever lock according to the invention;

FIG. 2 is an exploded, perspective view of the relevant parts by prior art;

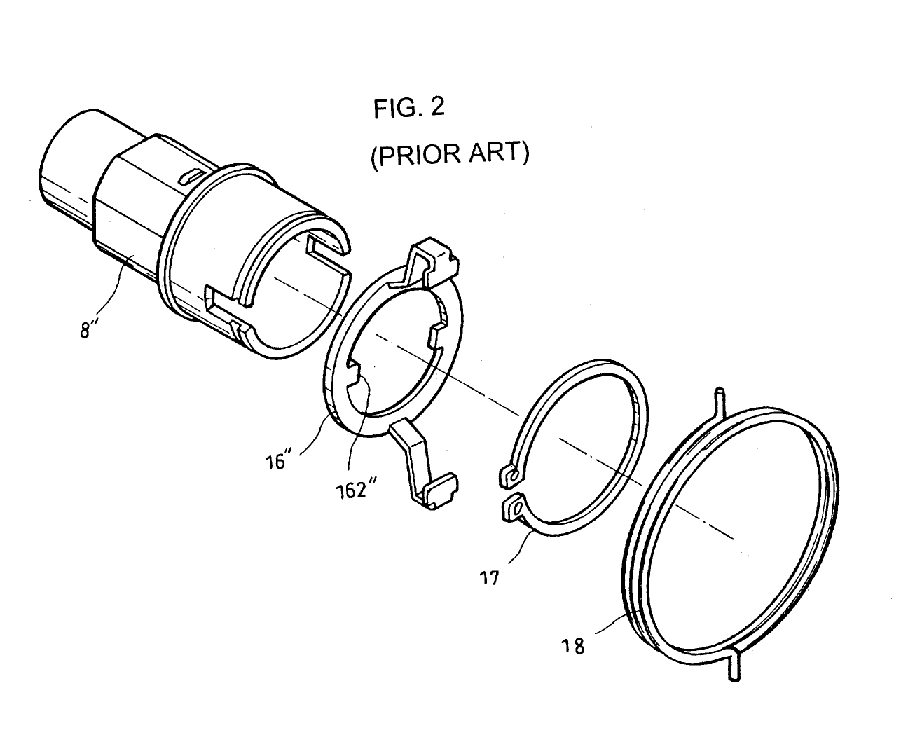

FIG. 3 is an exploded, perspective view of a first protection part according to the present invention;

FIG. 4 is an exploded, perspective view of a second protection part according to the present invention;

FIGS. 5A and 5B are cross sectional views showing the operation of the first protection part; and

FIGS. 6A and 6B are cross sectional views showing the operation of the first protection part.

### DETAILED DESCRIPTION OF THE PREFERRED EMBODIMENTS

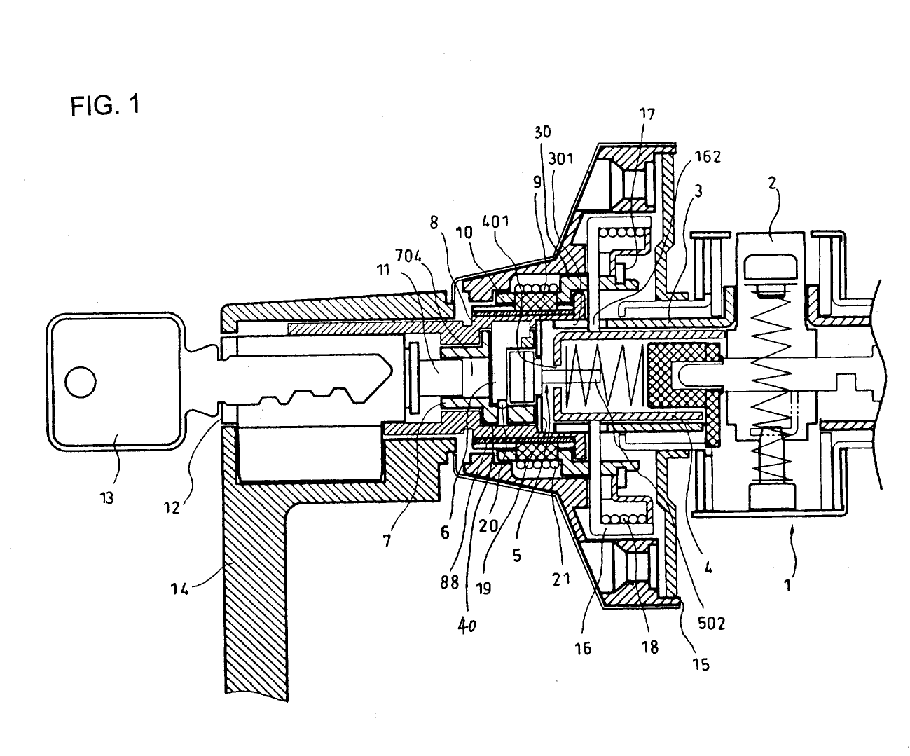

FIG. 1 shows an anti-break cylindrical lever lock 1 according to the invention. The lock 1 comprises an outside lever 14 having a key cylinder 12, a locking bar 2, an outer spindle 3, an inner spindle 4, a first protection part 30 provided between the outside lever 14 and the outer spindle 3, and a second protection part 40 provided between the key cylinder 12 and the inner spindle 4. The cylindrical lever lock 1 also has an attachment plate 15, and a spring bracket snap ring 17.

The outer spindle 3 is connected to the locking bar 2 in a manner that rotation of the outer spindle 3 makes the locking bar 2 protrude or retract. Also, the inner spindle 4 is connected to the locking bar 2 in a manner that rotation of the inner spindle 4 makes the locking bar 2 protrude or retract. The outer spindle 3 and the inner spindle 4 cannot be rotated when the cylindrical lever lock 1 is locked, and the outer spindle 3 and the inner spindle 4 can be rotated when the cylindrical lever lock 1 is unlocked. When the cylindrical lever lock 1 is locked and external force is exerted on the outside lever 14, the first protection part 30 makes the outside lever 14 rotate idle separately from the outer spindle 3, and the second protection part 40 makes the key cylinder 12 rotate idle separately from the inner spindle 4.

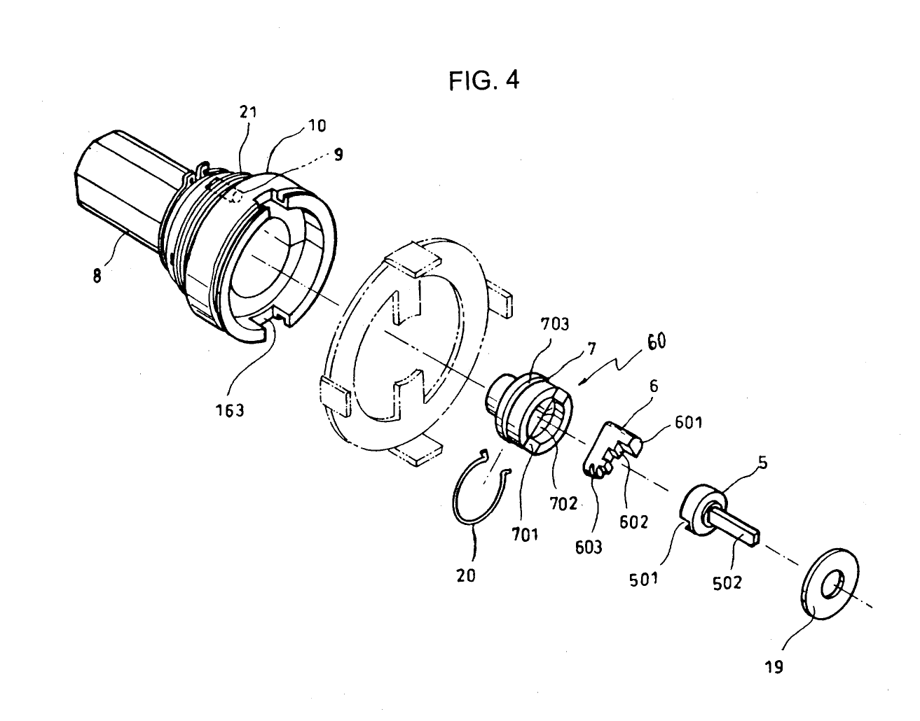

That is, under the state that the lever lock 1 is locked, when an excessive force is exerted on an outside lever 14, the outside lever 14 rotates idle. In addition, an unlocking bracket 5, which is explained later with reference to FIG. 4, rotates idle when a proper key is not inserted but the outside lever 14 is rotated with excessive force. Thus, internal parts of the lever lock are protected from deforming or being broken.

The first protection part 30 has a rotating tube 8 that rotates integrally with the outside lever 14, and a coupling cylinder assembly 50 that is rotationally engaged with the rotating tube 8. The coupling cylinder assembly 50 is also rotationally engaged with the outer spindle 3. The rotating tube 8 rotates separately from the coupling cylinder assembly 50 when the cylindrical lever lock 1 is locked and external force is exerted on the outside lever 14.

The coupling cylinder assembly 50 has a coupling cylinder 10, two coupling rods 9 and an elastic spring 21. The rotating tube 8 has two longitudinal inclined grooves 801 and the coupling cylinder 10 has two guide channels 101. The longitudinal inclined groove 801 and the guide channel 101 are aligned and the coupling rod 9 is received in the longitudinal inclined groove 801 and the guide channel 101. The elastic spring 21 presses the coupling rod 9 radially inward. When the cylindrical lever lock 1 is locked and external force is exerted on the outside lever, the coupling rod 9 moves out of the longitudinal inclined groove 801 and slides on the rotating tube 8 until the longitudinal inclined groove 801 and the guide channel 101 are aligned again. In this way, the rotating tube 8 rotates separate from the coupling cylinder assembly 50.

The rotating tube may further have a ring 88 and the longitudinal inclined groove 801 is provided on the ring 88. The ring 88 is made of hardened steel.

The lock 1 includes a spring bracket 16. The spring bracket 16 has two coupling protrusions 162 that are received in the coupling recesses 163 provided in the coupling cylinder 10 and in side recesses 301 provided in the outer spindle 3. In this way, the coupling cylinder 10 is rotationally engaged with the outer spindle 3.

The operation of the first protection part 30 is explained in more detail. The rotating tube 8 is connected to the outside lever 14 and to the coupling cylinder 10, which in turn is engaged with the side recesses 301 of the outer spindle 3. The rotating tube 8 rotates separately from the coupling cylinder 10 if excessive force is applied.

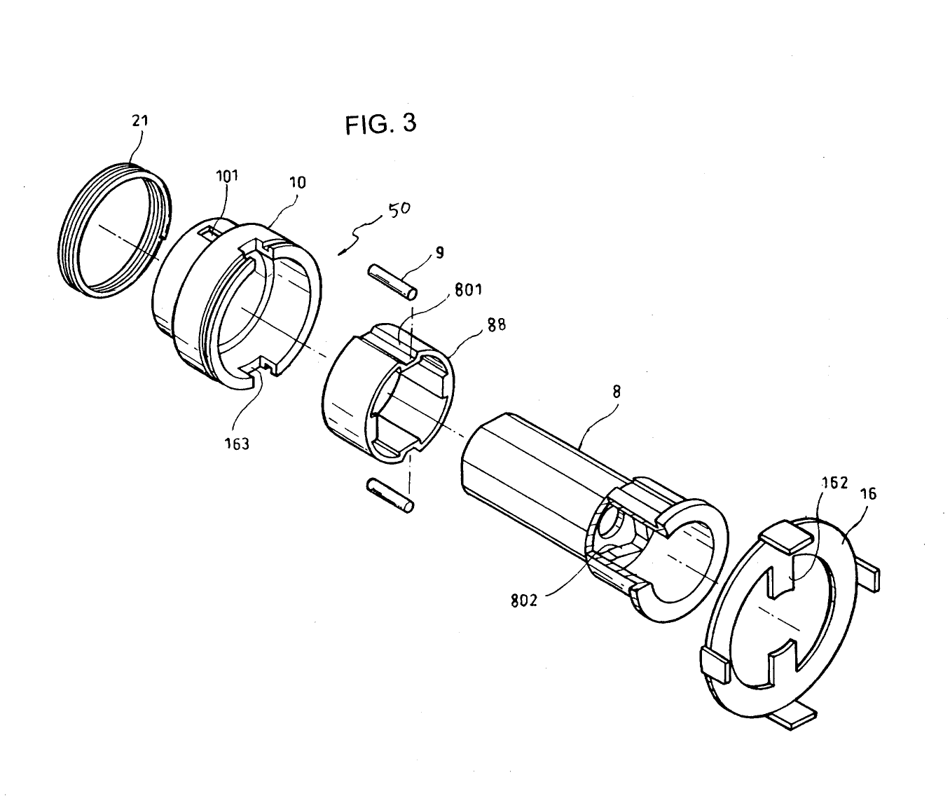

FIGS. 3 and 4 show how the outside lever 14 is allowed to rotate idle. The coupling cylinder 10 has the guide channels 101 and the coupling recesses 163. The spring bracket 16 has the coupling protrusions 162 that are inserted into the coupling recesses 163. The rotating tube 8 passes through the coupling cylinder 10. The ring 88 is integrally assembled with the rotating tube 8. The ring 88 has two longitudinal inclined grooves 801. The longitudinal inclined groove 801 has inclined surfaces to facilitate the movement of the coupling rod 9.

The circular coupling rod 9 is inserted between the longitudinal inclined groove 801 and the guide channel 101 when the rotating tube 8 and the coupling cylinder 10 are assembled. The elastic spring 21 presses the coupling rods 9 radially inward. About half of the coupling rod 9 is received in the longitudinal inclined groove 801. Thus, the rotating tube 8 and the coupling cylinder 10 are connected in this way. An outside lever return spring 18 is engaged with the spring bracket 16 (refer to FIG. 1). The coupling protrusion 162 is also inserted into the side recess 301 of the outer spindle 3 (refer to FIG. 1).

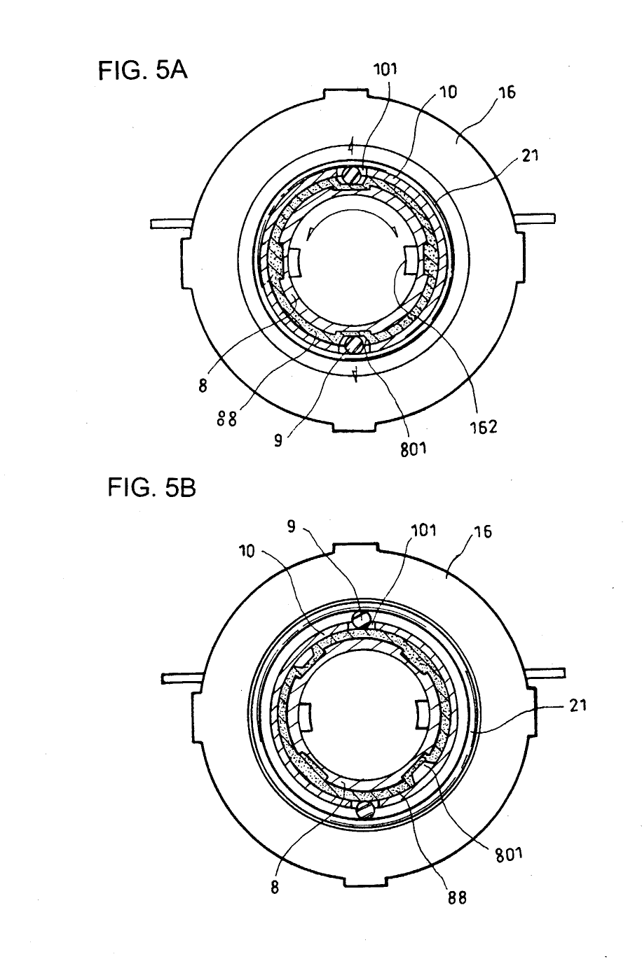

FIGS. 5A and 5B show the operation of the first protection part 30. When the outside lever 14 is rotated with an excessive external force under the state that the cylindrical lever lock 1 is locked, the rotating tube 8 is rotated. Then the coupling rod 9 moves out of the longitudinal inclined groove 801 overcoming the force of the elastic spring 21. The coupling rod 9 expands the elastic spring 21 and slides on the outer periphery of the ring 88 as shown in FIG. 5B. Thus, the rotating tube 8 is rotated while the coupling cylinder 10 is not rotated. Since the outside lever is integrally connected with the rotating tube 8, the outside lever 14 rotates idle when an excessive force is exerted on the outside lever 14.

The ring 88 and the rotating tube 8 keeps rotating idle until the guide channel 101 of the coupling cylinder 10 and the longitudinal inclined groove 801 of the ring 88 are aligned again. Then the coupling rod 9 is inserted between the longitudinal inclined groove 801 and the guide channel 101 again.

If the excessive external force exerted on the outside lever 14 persists still, the coupling rod 9 moves out of the longitudinal inclined groove 801 again, and the outside lever 14 rotates idle again.

The coupling rod's moving out of the longitudinal inclined groove 801 against the force of the elastic spring 21 exerts substantial force on the longitudinal inclined groove 801. Therefore, the longitudinal inclined groove 801 is prone to wear. In order to prevent the wear, the ring 88 is made of hardened steel. Specifically, the ring 88 is cast with iron and heat treated to have the required hardness.

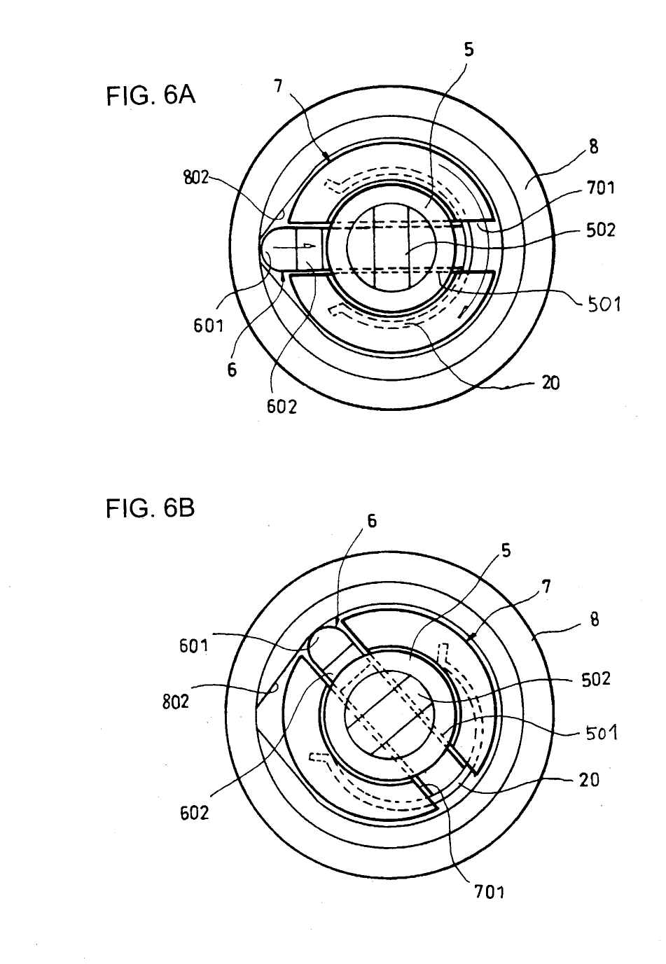

The operation of the second protection part is explained with FIGS. 4, 6A and 6B. While incorporating the first protection part into a prior art cylindrical lever lock allows idle rotation of the outside lever 14 separate from the outer spindle 3, another mechanism is needed to prevent unlocking of the cylindrical lever lock 1 and to protect a key cylinder rod 11 that is connected to the key cylinder 12.

The second protection part 40 has the unlocking bracket 5 and a connection bracket assembly 60. The connection bracket assembly 60 is rotationally engaged with the key cylinder 12. The unlocking bracket 5 is rotationally engaged with the inner spindle 4. The connection bracket assembly 60 rotates separately from the unlocking bracket 5 when the cylindrical lever lock 1 is locked and external force is exerted on the outside lever 14.

The connection bracket assembly 60 has a connection bracket 6, a connection bracket cylinder 7 and a connection bracket spring 20.

The connection bracket cylinder 7 is rotationally engaged with the key cylinder 12. The connection bracket cylinder 7 has a transverse cut portion 701, a circular step 702 and an annular groove 703. The unlocking bracket 5 can rotate on the circular step 702. The connection bracket 6 rests on the transverse cut portion 701. The connection bracket spring 20 is received in the annular groove 703.

The connection bracket 6 has a rounded surface portion 601 and a protruding stop 602 adjacent the rounded surface portion 601.

The unlocking bracket 5 has a transverse cut groove 501 and the rotating tube 8 further has an inclined groove 802 (refer to FIG. 3).

The connection bracket 6 can move transversely in the transverse cut groove 501. The rounded surface portion 601 is received in the inclined groove 802 and the protruding stop 602 is positioned outside the transverse cut groove 501 so that the connection bracket cylinder 7 can rotate separately from the unlocking bracket 5. When the cylindrical lever lock 1 is unlocked by a key 13, the rotation of the key cylinder 12 rotates the connection bracket cylinder 7 relative to the rotating tube 8, making the rounded surface portion 601 slide on the inclined groove 802 against the force of the connection bracket spring 20 and the protruding stop 602 be inserted into the transverse cut groove 501. In this way, the rotation of the connection bracket cylinder 7 rotates the unlocking bracket 5.

The connection bracket 6 has a spring recess 603 in which the connection bracket spring 20 is received.

The connection bracket cylinder 7 has a rectangular hole 704, and the key cylinder rod 11 is inserted into the rectangular hole 704 (refer to FIG. 1).

The unlocking bracket 5 has a column 502 that is inserted into a slot 401 provided in the inner spindle (refer to FIG. 1). The column 502 has rectangular shape.

The second protection part 40 has a cover 19 that covers the unlocking bracket 5 between the unlocking bracket 5 and the inner spindle 4.

The operation of the second protection part 40 is explained in more detail. The unlocking bracket 5, the connection bracket 6, and the connection bracket cylinder 7 are provided between the key cylinder rod 11 and an inner spindle 4. When the rotating tube 8, which is fixed to the outside lever 14, rotates idle in response to an excessive force, the unlocking bracket 5, which is connected to the inner spindle 4, remain static. When the key 13 is inserted into the key cylinder 12 and rotated, the unlocking bracket 5 is rotated and unlocks the cylindrical lever lock 1.

The inclined groove 802 is provided on the inner periphery of the rotating tube 8 (refer to FIGS. 3, 6A, and 6B). The connection bracket cylinder 7 is positioned parallel to the inclined groove 802. The connection bracket cylinder 7 has the rectangular hole 704 on one end, into which the key cylinder rod 11 is inserted (refer to FIG. 1). The transverse cut portion 701, on which the connection bracket 6 rests, is formed on the other end of the connection bracket cylinder 7. The circular step 702, on which the unlocking bracket 5 rotates idle, is formed between the ends of the connection bracket cylinder 7. The connection bracket spring 20 is inserted into the annular groove 703 that is formed on the outer periphery of the of the connection bracket cylinder 7.

The connection bracket 6 has the shape of a generally rectangular rod with rounded ends. The rounded surface portion 601 is formed on one end. The protruding stop 602 is formed adjacent to the rounded surface portion 601. The spring recess 603 is formed on the other end of the connection bracket 6. The unlocking bracket 5 has the transverse cut groove 501 on one end, and the column 502 on the other end. When the connection bracket 6 is assembled, the rounded surface portion 601 is received in the inclined groove 802, and the unlocking bracket 5 rests on the circular step 702. The cover 19 covers the unlocking bracket 5.

In the assembled state, the column 502 is inserted into the slot 401 provided in the inner spindle 4, and the transverse cut portion 701 of the connection bracket cylinder 7 and the transverse cut groove 501 of the unlocking bracket 5 are aligned.

The operation of the unlocking bracket 5 is explained. In the locked state, the protruding stop 602 of the connection bracket 6 is positioned outside the transverse cut groove 501 of the unlocking bracket 5 as shown in FIG. 6A. Thus, the unlocking bracket 5 is allowed to rotate separately.

If the key 13 is inserted into the key cylinder 12 and rotated to unlock the cylindrical lever lock 1, then the key cylinder rod 11 is rotated. The rotation of the key cylinder rod 11 also rotates the connection bracket cylinder 7 since the key cylinder rod 11 is inserted into the rectangular hole 704 of the connection bracket cylinder 7. The rotation of the connection bracket cylinder 7 makes the rounded surface portion 601 of the connection bracket 6 slide on the inclined groove 802 of the rotating tube 8 against the force of the connection bracket spring 20. Then as shown in FIG. 6B, the protruding stop 602 of the connection bracket 6 is inserted into the transverse cut groove 501 of the unlocking bracket 5, which rests on the circular step 702 of the connection bracket cylinder 7. The transverse cut groove 501 is substantially wider than the protruding stop 602 so that the protruding stop 602 may be easily inserted into the transverse cut groove 501. In this way, the connection bracket cylinder 7 and the unlocking bracket 5 rotate together. Then the inner spindle 4, which is connected to the unlocking bracket 5, is also rotated, and thus the locking bar 2 connected to the inner spindle 4 retracts into the cylindrical lever lock 1 unlocking the cylindrical lever lock 1.

After unlocking, when the key cylinder 12 is rotated in the reverse direction to take the key 13 out, the connection bracket cylinder 7 is also rotated in the reverse direction since it is engaged with the key cylinder rod 11. Then the rounded surface portion 601 of the connection bracket 6 is returned into the inclined groove 802 of the rotating tube 8 by the returning force of the connection bracket spring 20. This makes the protruding stop 602 of the connection bracket 6 to move out of the transverse cut groove 501 of the unlocking bracket 5 allowing the connection bracket 7 to rotate separately. In this way, the unlocking bracket 5 either remains static or unlocks the cylindrical lever lock 1.

With the above construction, even though an excessive force is applied on the lever lock, the relevant parts inside the lever lock rotates idle, and thus the excessive external force is not transferred to the internal elements. Therefore the cylindrical lever lock is protected from malicious breaking. This anti-break feature is provided by adding just several small parts, while keeping the widely used cylindrical lever lock structure unchanged. Therefore, cylindrical lever locks having the anti-break feature can be manufactured with low additional cost.

Although the invention has been described in considerable detail, other versions are possible by converting the aforementioned construction. Therefore, the scope of the invention shall not be limited by the specification specified above.

What is claimed is:

1. A cylindrical lever lock comprising:
a) an outside lever having a key cylinder;
b) a locking bar;
c) an outer spindle;
d) an inner spindle;
e) a first protection part provided between the outside lever and the outer spindle; and
f) a second protection part provided between the key cylinder and the inner spindle;
wherein the outer spindle is connected to the locking bar in a manner that rotation of the outer spindle makes the locking bar protrude or retract;
wherein the inner spindle is connected to the locking bar in a manner that rotation of the inner spindle makes the locking bar protrude or retract;
wherein the outer spindle and the inner spindle cannot be rotated when the cylindrical lever lock is locked, and the outer spindle and the inner spindle can be rotated when the cylindrical lever lock is unlocked, wherein when the cylindrical lever lock is locked and external force is exerted on the outside lever, the first protection part makes the outside lever rotate idle separately from the outer spindle, and the second protection part makes the key cylinder rotate idle separately from the inner spindle.

2. The cylindrical lever lock of claim 1, wherein the first protection part has a rotating tube that rotates integrally with the outside lever, and a coupling cylinder assembly that is rotationally engaged with the rotating tube, wherein the coupling cylinder assembly is rotationally engaged with the outer spindle, and wherein the rotating tube rotates separate from the coupling cylinder assembly when the cylindrical lever lock is locked and external force is exerted on the outside lever.

3. The cylindrical lever lock of claim 2, wherein the second protection part has a unlocking bracket and a connection bracket assembly, wherein the connection bracket assembly is rotationally engaged with the key cylinder, wherein the unlocking bracket is rotationally engaged with the inner spindle, wherein the connection bracket assembly rotates separately from the unlocking bracket when the cylindrical lever lock is locked and external force is exerted on the outside lever.

4. The cylindrical lever lock of claim 3, wherein the coupling cylinder assembly has a coupling cylinder, a coupling rod and an elastic spring, wherein the rotating tube has a longitudinal inclined groove and the coupling cylinder has a guide channel, wherein the longitudinal inclined groove and the guide channel are aligned and the coupling rod is received in the longitudinal inclined groove and the guide channel, wherein the elastic spring presses the coupling rod radially inward, wherein when the cylindrical lever lock is locked and external force is exerted on the outside lever, the coupling rod moves out of the longitudinal inclined groove and slides on the rotating tube until the longitudinal inclined groove and the guide channel are aligned again, whereby the rotating tube rotates separate from the coupling cylinder assembly.

5. The cylindrical lever lock of claim 4, wherein the rotating tube further has a ring and the longitudinal inclined groove is provided on the ring.

6. The cylindrical lever lock of claim 5, wherein the ring is made of hardened steel.

7. The cylindrical lever lock of claim 4, further comprising a spring bracket, wherein the spring bracket has a coupling protrusion that is received in a coupling recess provided in the coupling cylinder and in a side recess provided in the outer spindle, whereby the coupling cylinder is rotationally engaged with the outer spindle.

8. The cylindrical lever lock of claim 3, wherein the connection bracket assembly has a connection bracket, a connection bracket cylinder and a connection bracket spring, wherein the connection bracket cylinder is rotationally engaged with the key cylinder, wherein the connection bracket cylinder has a transverse cut portion, a circular step and an annular groove, wherein the unlocking bracket can rotate on the circular step, wherein the connection bracket rests on the transverse cut portion, wherein the connection bracket spring is received in the annular groove, wherein the connection bracket has a rounded surface portion and a protruding stop adjacent the rounded surface portion, wherein the unlocking bracket has a transverse cut groove and the rotating tube further has an inclined groove, wherein the connection bracket can move transversely in the transverse cut groove, wherein the rounded surface portion is received in the inclined groove and the protruding stop is positioned outside the transverse cut groove so that the connection bracket cylinder can rotate separately from the unlocking bracket, wherein when the cylindrical lever lock is unlocked by a key, the rotation of the key cylinder rotates the connection bracket cylinder relative to the rotating tube making the rounded surface portion slide on the inclined groove against the force of the connection bracket spring and the protruding stop be inserted into the transverse cut groove, whereby the rotation of the connection bracket cylinder rotates the unlocking bracket.

9. The cylindrical lever lock of claim 8, wherein the connection bracket further has a spring recess in which the connection bracket spring is received.

10. The cylindrical lever lock of claim 8, wherein the key cylinder has a key cylinder rod, and the connection bracket cylinder has a hole, and wherein the key cylinder rod is inserted into the hole.

11. The cylindrical lever lock of claim 8, wherein the unlocking bracket further has a column that is inserted into a slot provided in the inner spindle.

12. The cylindrical lever lock of claim 11, wherein the second protection part further has a cover that covers the unlocking bracket between the unlocking bracket and the inner spindle.

13. The cylindrical lever lock of claim 5, wherein the connection bracket assembly has a connection bracket, a connection bracket cylinder and a connection bracket spring, wherein the connection bracket cylinder is rotationally engaged with the key cylinder, wherein the connection bracket cylinder has a transverse cut portion, a circular step and an annular groove, wherein the unlocking bracket can rotate on the circular step, wherein the connection bracket rests on the transverse cut portion, wherein the connection bracket spring is received in the annular groove, wherein the connection bracket has a rounded surface portion and a protruding stop adjacent the rounded surface portion, wherein the unlocking bracket has a transverse cut groove and the rotating tube further has an inclined groove, wherein the connection bracket can move transversely in the transverse cut groove, wherein the rounded surface portion is received in the inclined groove and the protruding stop is positioned outside the transverse cut groove so that the connection bracket cylinder can rotate separately from the unlocking bracket, wherein when the cylindrical lever lock is unlocked by a key, the rotation of the key cylinder rotates the connection bracket cylinder relative to the rotating tube making the rounded surface portion slide on the inclined groove against the force of the connection bracket spring and the protruding stop be inserted into the transverse cut groove, whereby the rotation of the connection bracket cylinder rotates the unlocking bracket.

14. The cylindrical lever lock of claim 13, wherein the connection bracket further has a spring recess in which the connection bracket spring is received.

15. The cylindrical lever lock of claim 13, wherein the key cylinder has a key cylinder rod, and the connection bracket cylinder has a hole, and wherein the key cylinder rod is inserted into the hole.

16. The cylindrical lever lock of claim 13, wherein the unlocking bracket further has a column that is inserted into a slot provided in the inner spindle.

17. The cylindrical lever lock of claim 16, wherein the second protection part further has a cover that covers the unlocking bracket between the unlocking bracket and the inner spindle.
